(19) United States
(12) Patent Application Publication
(10) Pub. No.: US 2005/0036884 A1
(43) Pub. Date: Feb. 17, 2005

(54) Die pickup method and die pickup device

(75) Inventors: Takashi Takeuchi, Higashiyamato (JP); Taito Kobayashi, Kodaira (JP)

Correspondence Address: KODA & ANDROLIA, 2029 CENTURY PARK EAST, SUITE 1430, LOS ANGELES, CA, 90067-3024, US

(73) Assignee: Kabushiki Kaisha Shinkawa

(21) Appl. No.: 10/916,348

(22) Filed: Aug. 11, 2004

(30) Foreign Application Priority Data
Aug. 11, 2003 (JP) 2003-291117

(51) Int. Cl. B65G 65/04

(52) U.S. Cl. 414/811

(57) ABSTRACT

A die pickup method and device including a collet 4 that vacuum-chucks dies 1A, 1B, IC . . . , which are on a wafer sheet 2, and a suction stage 6, which vacuum-sucks this wafer sheet 2. A protruding surface 21 is formed on the upper surface of the suction stage 6 so that it is located on the feeding (upstream) side in the direction in which dies are fed to the die pickup center 5 of the suction stage 6. The wafer sheet 2 being vacuum-sucked by the suction stage 6 is fed so that a die 1A that is to be picked up is moved toward the die pickup center 5, thus allowing the die 1A to be separated from the wafer sheet 2 as the die 1A passes the protruding surface 21, and then the die 1A is vacuum-chucked and picked up by the collet 4.

### BACKGROUND OF THE INVENTION

1. Technical Field

The present invention relates to a die pickup method and a die pickup device (jig) which peel dies, which are bonded to a wafer sheet, away from this wafer sheet and pick up these dies.

2. Description of the Related Art

Generally, a push-up needle system is used as a die pickup method for dies that are bonded to a wafer sheet. However, this method has a problem. In cases where the thickness of the die is small, i.e., approximately 100 μm or less, the die is likely to be damaged.

Japanese Patent Application Laid-Open (Kokai) No. 2001-118862 (Japanese Patent No. 3209736), ameliorating the above-described problem, discloses a method that picks up dies from a wafer sheet without using a push-up needle. Seven embodiments are involved in this prior art; and in all of these embodiments, a die that is to be picked up is moved to a die pickup center, after which the die is held by a collet and is then peeled away from the wafer sheet by causing the suction stage to move or by causing only a protruding portion formed on the upper surface of the suction stage to move.

In the above-described prior art, after a die has been moved to the die pickup center, the suction stage is moved or the protruding part alone is moved, so that the wafer sheet is peeled from the die. Accordingly, it takes time, and the productivity is poor. Furthermore, a driving means is needed in order to drive the suction stage or to drive the protruding portion of the suction stage, causing the die pickup system to be expensive.

### BRIEF SUMMARY OF THE INVENTION

The object of the present invention is to provide a die pickup method and a die pickup device (jig) that shorten the pickup time and lower the cost of die pickup system.

The above object is accomplished by a unique sequential steps of the present invention for a method for picking up a die with a collet used in a die pickup device that includes the collet, which is vertically movable and vacuum-chucks a die bonded to a wafer sheet, and a suction stage, which vacuum-sucks the wafer sheet; and in the present invention,
the suction stage is formed with a protruding surface on its upper surface so that the protruding surface is on a feeding (or upstream) side in a direction in which a die that is to be picked up is fed to a die pickup center of the suction stage; and
the die pickup method comprises the steps of: feeding the wafer sheet, which is being vacuum-sucked by the suction stage, so that the die to be picked up is positioned in the die pickup center, thus causing the die to be picked up to be separated from the wafer sheet as the die to be picked up passes the protruding surface; and lowering the collet to vacuum-chuck the separated die therewith, and raising the collet to pick up the separated die with the collet.

The above object is accomplished by another unique sequential steps of the present invention for a method for picking up a die with a collet used in a die pickup device that includes the collet, which is vertically movable and vacuum-chucks a die bonded to a wafer sheet, and a suction stage, which vacuum-sucks the wafer sheet; and in the present invention,
the suction stage is formed with a protruding surface on its upper surface so that the protruding surface is on a feeding (or upstream) side in a direction in which a die that is to be picked up is fed to a die pickup center of the suction stage; and
the die pickup method comprises the steps of: lowering the collet to vacuum-chuck the die to be picked up by the collet before the die to be picked up is fed to the die pickup center; feeding the wafer sheet and the collet to the die pickup center in synchronization, thus separating the die to be picked from the wafer sheet as the die to be picked up passes the protruding surface; and raising the collet so as to pick up the separated die with the collet.

The above object is accomplished by a unique structure for a device for picking up a die with a collet that includes the collet, which vacuum-chucks a die bonded to a wafer sheet, and a suction stage, which vacuum-sucks the wafer sheet; and in the present invention, the suction stage is comprised of:
a suction tube that vacuum-sucks the wafer sheet,
side blocks which are provided so as to make an upward and downward movement on both side surfaces of the suction tube in a die feeding direction in which the die that is to be picked up is fed to a die pickup center of the suction tube, the side blocks protruding from an upper surface of the suction tube when moved upward, and
an adjustment nut which is screw-engaged with the suction tube to allow the side blocks to be moved upward and downward; and
the width of portions of the side blocks that protrude from the upper surface of the suction tube is set to be smaller than the width of the die.

In the above structure of the die pickup device, the suction tube is formed with a plurality of suction grooves which are parallel to the die feeding direction.

In the above die pickup method and devices, when a die that is to be picked up is moved to a die pickup center, a portion of the wafer sheet that corresponds to this die is fed so that the wafer sheet is peeled (or the die is separated from the wafer sheet) at the protruding surface of suction stage by vacuum suction in the suction stage as the die passes the protruding surface. Accordingly, the bonding strength between the wafer sheet and the die drops at the edge of the protruding surface; and thus, since the pickup of the die is performed by the collet, the pickup time is shortened. Furthermore, since there is no need for a driving means that causes the horizontal and/or rotational movement of the suction stage or protruding surface, the cost of the die pickup system can be reduced.

### BRIEF DESCRIPTION OF THE DRAWINGS

FIG. 1A is a top view of the die pickup jig (die pickup device) according to one embodiment of the present invention, FIG. 1B is a sectional view thereof taken along the line 1B-1B in FIG. 1A, FIG. 1C is a sectional view thereof taken along the line 1C-1C in FIG. 1A, and FIG. 1D is a right side view thereof;

FIGS. 2A through 2C show the process of the die pickup method according to one embodiment of the present invention; and

FIGS. 3A through 3C show the process of the die pickup method according to another embodiment of the present invention.

### DETAILED DESCRIPTION OF THE INVENTION

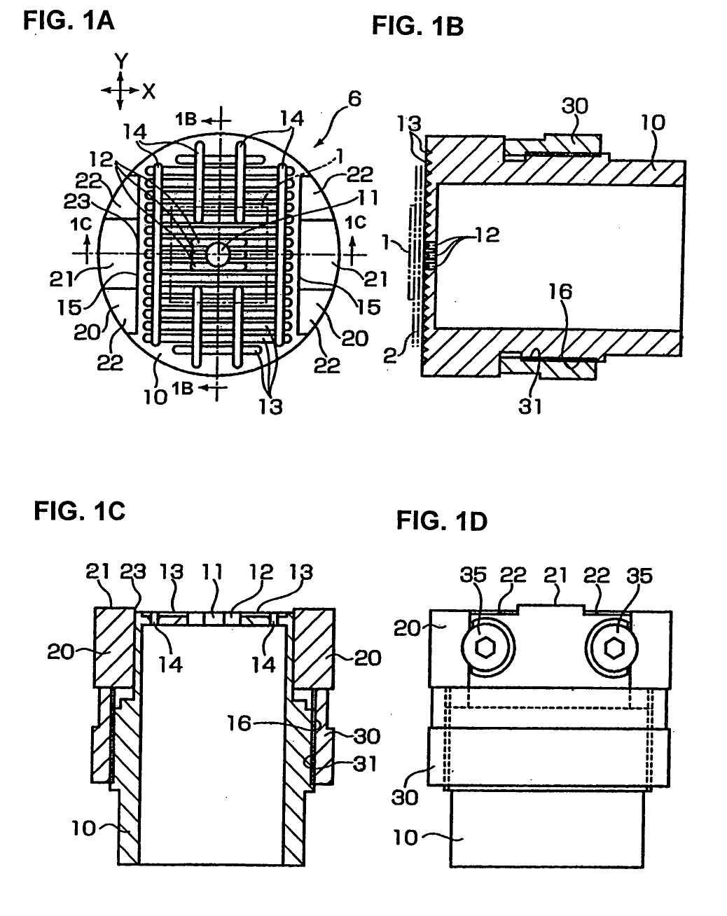

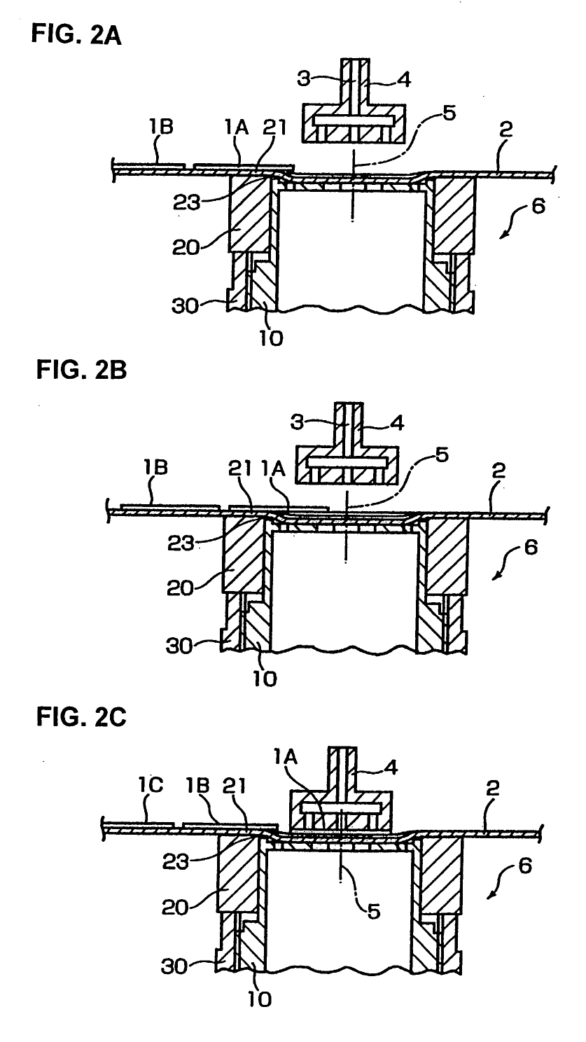

The outer circumference of a wafer sheet 2 on which dies 1A, 1B, 1C . . . are bonded as shown in FIGS. 2A through 2C is fastened to a wafer ring (not shown in the drawings); and this wafer ring is fastened to a wafer supporting frame (not shown in the drawings) that is driven in the directions of the X and Y axes in the horizontal plane (see FIG. 1A). Each die 1A, 1B, 1C . . . is vacuum-chucked and picked up by a collet 4 in which suction chucking holes 3 are formed. A suction stage 6 that vacuum-sucks the wafer sheet 2 is provided beneath the collet 4 so that the die pickup center 5 of the suction stage 6 is aligned with the center of suction chucking hole 3 of the collet 4.

The structure described so far above belongs to a known technique.

As shown in FIGS. 1A through 1D, the suction stage 6 is comprised of a suction tube 10, side blocks 20 that are provided on the upper portions of both side surfaces (see FIG. 1A) of this suction tube 10, and an adjustment nut 30 that adjusts the positions of these side blocks 20 in the vertical direction.

A round suction hole 11 which is a round through-hole is formed in the center of the top plate (or the upper surface) of the suction tube 10, and three suction slits 12 which are through-slits (that penetrate the upper surface of the suction tube 10) are formed parallel to the direction in which the dies 1A, 1B, 1C . . . are fed (from right to left in, for instance, FIG. 2A) to the die pickup center 5 (hereafter referred to as the “X-axis direction”) so that the slits 12 are positionally correspond to this round suction hole 11 and on both sides of this round suction hole 11. Furthermore, a plurality of suction grooves 13 are formed in the upper surface of the suction tube 10 so that such grooves 13 are parallel to the X-axis direction. In addition, a plurality of suction slits 14 which are through-slits are formed in the direction of the Y axis in order to apply suction to these suction grooves 13.

Block raising-and-lowering guides 15 are provided in a vertical attitude on both upper side portions (with respect to the X-axis direction) of the suction tube 10, and the side blocks 20 are fastened to the block raising-and-lowering guides 15 by bolts 35. A screw part 16 is formed on the outer circumference of the suction tube 10 so as to be below the block raising-and-lowering guides 15, and a screw part 31 formed on the adjustment nut 30 is screw-engaged with this screw part 16 of the suction tube 10, so that the upper surface of the adjustment nut 30 is in contact with the undersurfaces of the side blocks 20. The upper surface of each side block 20 is formed with a protruding surface 21 and relief surfaces 22. The width of the protruding surface 21 is smaller than the width of the a die 1A, 1B, 1C . . . , and the relief surfaces 22 are approximately 200 μm lower than this protruding surface 21.

Accordingly, when the bolts 35 are loosened, the side blocks 20 can be raised or lowered by turning the adjustment nut 30. The protruding surfaces 21 of the side blocks 20 are thus set, for instance, approximately 50 μm higher than the upper surface of the suction tube 10. Then, the bolts 35 are tightened back so that the side blocks 20 are fastened to the suction tube 10.

Next, the die pickup method will be described.

As shown in FIG. 2A, the vacuum of the suction stage 6 is switched on, and the wafer ring (not shown in the drawings) to which the wafer sheet 2 is fastened is moved by one pitch in the X-axis direction (to the right side) as shown in FIGS. 2B and 2C, so that the die 1A that is to be picked up is positioned in the die pickup center 5. Since the upper surfaces of the side blocks 20 have a width that is smaller than the width of the die 1A and are set approximately 50 μm higher than the upper surface of the suction tube 10 as described above, when the wafer sheet 2 is fed, the wafer sheet 2 is peeled away or separated from the die 1A by the edge 23 of the corresponding side block 20, which is on the feeding side or on the upstream side in the direction of the feeding of the die and has the protruding surface, as a result of the vacuum suction created by the suction tube 10 when the die 1A is fed to the die pickup center 5 as described above; furthermore, since suction is applied to the wafer sheet 2 by the suction grooves 13, the bonding strength between the wafer sheet 2 and die 1A drops at the edge 23. When the die 1A is fed to the die pickup center 5, the collet 4 is lowered and the die 1A is picked up by the collet 4 as shown in FIG. 2C. In this case, since the bonding strength between the wafer sheet 2 and die 1A has dropped, the collet 4 can easily pick up the die 1A.

The collet 4 that has picked up the die 1A by vacuum chucking is raised and moved in the X- and Y-axis directions by conveying means (not shown in the drawings), and the next process, e.g., a process such as die bonding, die filling, etc., is performed. When the die 1A is picked up, the die 1B that is to be picked up next is fed to the die pickup center 5 by the above-described operation.

Since pickup of the die 1A by the collet 4 is performed immediately after the die 1A (that is to be picked up) is fed to the die pickup center 5, the pickup time is shortened. In addition, since a driving means that causes horizontal and/or rotational movement of the suction stage 6 or protruding elements is required, the cost of the system is reduced.

Furthermore, since the suction grooves 13 are formed parallel to the feeding direction to the feeding direction of the dies 1A, 1B, 1C . . . (i.e., the X-axis direction), the wafer sheet 2 can be fed relatively smoothly.

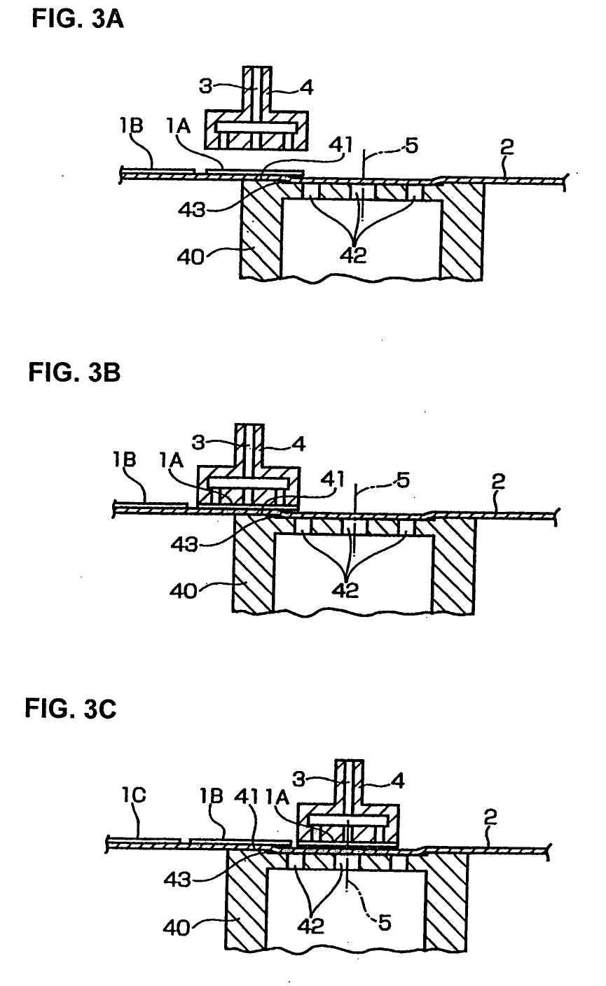

Another embodiment of the die pickup method of the present invention will be described with reference to FIGS. 3A through 3C.

In the suction stage 40, protruding surfaces 41 are formed on the upper surface on both sides of the die pickup center 5 with respect to the X-axis direction (die feeding direction). The suction stage 40 is provided with suction holes 42.

With this structure, after the vacuum of the suction stage 40 has been switched on, and the collet 4 has been positioned above the die 1A that is to be picked up, the collet 4 is lowered so that the die 1A is vacuum-chucked by the collet 4 as shown in FIG. 3B. Next, as shown in FIG. 3C, the collet 4 and the wafer ring (not shown in the drawings) to which the wafer sheet 2 is fastened are moved in synchronization by one pitch in the X-axis direction. Since the wafer sheet 2 is vacuum-sucked by suctions holes 42 of the suction stage 40, and the die 1A is vacuum-chucked by the collet 4, the wafer sheet 2 is peeled from the die 1A by the edge 43 of the corresponding protruding surface 41 of the suction stage 40.

In this embodiment of FIGS. 3A through 3C as well, the pickup of the die 1A is accomplished merely by raising the collet 4 after the die 1A that is to be picked up is fed to the die pickup center 5. Accordingly, the pickup time is shortened in the same manner as in the above-described embodiment; and since there is no need for a driving means that causes horizontal and/or rotational movement of the suction stage 6, the cost of the die pickup system is reduced.

1. A method for picking up a die with a collet, said method being used in a die pickup device that comprises said collet which is vertically movable and vacuum-chucks a die on a wafer sheet and a suction stage which vacuum-sucks said wafer sheet, wherein
said suction stage is formed with a protruding surface on an upper surface thereof so that said protruding surface is on a feeding side in a direction in which a die that is to be picked up is fed to a die pickup center of said suction stage; and
said method comprises the steps of:
feeding said wafer sheet, which is being vacuum-sucked by said suction stage, so that said die to be picked up is positioned in said die pickup center, thus causing said die to be picked up to be separated from said wafer sheet as said die to be picked up passes said protruding surface;
lowering said collet to vacuum-chuck said separated die therewith; and
raising said collet to pick up said separated die.

2. A method for picking up a die with a collet, said method being used in a die pickup device that comprises said collet which is vertically movable and vacuum-chucks a die on a wafer sheet and a suction stage which vacuum-sucks said wafer sheet, wherein
said suction stage is formed with a protruding surface on an upper surface thereof so that said protruding surface is on a feeding side in a direction in which a die to be picked up is fed to a die pickup center; and
said method comprises the steps of:
lowering said collet to vacuum-chuck said die to be picked up by said collet before said die to be picked up is fed to said die pickup center;
feeding said wafer sheet and said collet to said die pickup center in synchronization, thus separating said die to be picked from said wafer sheet as said die to be picked up passes said protruding surface; and
raising said collet so as to pick up said separated die.

3. A device for picking up a die with a collet, comprising said collet that vacuum-chucks a die on a wafer sheet and a suction stage that vacuum-sucks said wafer sheet, wherein said suction stage comprises:
a suction tube that vacuum-sucks said wafer sheet,
side blocks which are provided so as to make an upward and downward movement on both side surfaces of said suction tube in a die feeding direction in which said die that is to be picked up is fed to a die pickup center of said suction tube, said side blocks protruding from an upper surface of said suction tube when moved upward, and
an adjustment nut which is screw-engaged with said suction tube to allow said side blocks to be moved upward and downward; and
wherein a width of portions of said side blocks that protrude from said upper surface of said suction tube is set to be smaller than a width of said die.

4. The device according to claim 3, wherein said suction tube is formed with a plurality of suction grooves which are parallel to said die feeding direction.
